(19) United States
(12) Patent Application Publication
(10) Pub. No.: US 2013/0074945 A1
(43) Pub. Date: Mar. 28, 2013

(54) FUEL SYSTEM

(71) Applicants: Erhan Karaca, Clifton Park, NY (US); Robert Joseph Loeven, II, Simpsonville, SC (US)

(72) Inventors: Erhan Karaca, Clifton Park, NY (US); Robert Joseph Loeven, II, Simpsonville, SC (US)

(73) Assignee: GENERAL ELECTRIC COMPANY, Schenectady, NY (US)

(21) Appl. No.: 13/247,732

(22) Filed: Sep. 28, 2011

(51) Int. Cl. B67D 7/72

(52) U.S. Cl. 137/154

(57) ABSTRACT

A fuel system is provided and includes inert gas, fuel and air sources to provide a supply of inert gas, fuel and air, respectively, piping including valves delimiting cavities therein to which the inert gas, fuel and air are supplied such that the inert gas separates the respective cavities containing fuel and air, a pressure control valve disposed on the piping to modulate a pressure of the inert gas supplied to the piping and a controller coupled to the pressure control valve to control an operation thereof in accordance with at least variable pressures of the fuel and air in the respective cavities containing the fuel and the air.

### BACKGROUND OF THE INVENTION

The subject matter disclosed herein relates to a fuel system.

Some gas turbine fuel systems require inert gas blocking to separate fuel and air within the gas fuel piping. This is particularly true for systems using syngas and high hydrogen systems. In these cases, the inert gas must be maintained at a higher pressure than both the fuel and air pressures to effectively act as a block. This requirement of high pressure of the inert gas can, however, lead to the presence of excessively pressurized inert gas and possibly inert gas leakage, both of which increase operational costs.

### BRIEF DESCRIPTION OF THE INVENTION

According to one aspect of the invention, a fuel system is provided and includes inert gas, fuel and air sources to provide a supply of inert gas, fuel and air, respectively, piping including valves delimiting cavities therein to which the inert gas, fuel and air are supplied such that the inert gas separates the respective cavities containing fuel and air, a pressure control valve disposed on the piping to modulate a pressure of the inert gas supplied to the piping and a controller coupled to the pressure control valve to control an operation thereof in accordance with at least variable pressures of the fuel and air in the respective cavities containing the fuel and the air.

According to another aspect of the invention, a fuel system is provided and includes an inert gas source to provide inert gas to an inert gas cavity, fuel and air sources to provide fuel and air to fuel and air cavities, respectively, which are disposed on opposite sides of the inert gas cavity, a pressure control valve disposed downstream from the inert gas source and upstream from the inert gas cavity to modulate a pressure of the inert gas supplied to the inert gas cavity and a controller coupled to the pressure control valve to control an operation thereof in accordance with at least variable pressures of the fuel and air.

According to yet another aspect of the invention, a method of controlling an operation of a fuel system is provided and includes operating the fuel system on a primary or secondary fuel, in accordance with the operating, initiating or maintaining an inert gas block between air and the primary fuel, determining respective pressures of the air and the primary fuel and a required inert gas pressure to maintain the inert gas block and controlling a pressure control valve to modulate inert gas pressure in accordance with the determined required inert gas pressure.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic illustration of a fuel system;

FIG. 2 is a schematic diagram of a controller of the fuel system of FIG. 1; and

FIG. 3 is a flow diagram of a method of controlling an operation of a fuel system.

The detailed description explains embodiments of the invention, together with advantages and features, by way of example with reference to the drawings.

### DETAILED DESCRIPTION OF THE INVENTION

In dual fuel systems for gas turbine engines and other similar devices, inert gas is often provided at a constant pressure that is sufficient to maintain a separation between pressurized synthetic fuel (“syngas”) and compressed air. The air is normally used to purge the gas fuel nozzles while the unit is operating on the secondary fuel, which is normally liquid fuel. This may be accomplished by setting the inert gas pressure to a predefined safe pressure that is higher than a highest expected syngas pressure (i.e., approximately 50+ psi higher than the highest expected syngas pressure). In systems in which the syngas pressure is variable, however, the inert gas pressure may not be similarly variable and some operating modes thus occur in which the syngas pressure decreases and while the previously set inert gas pressure remains constant. In those systems, inert gas pressure is often much higher than necessary to maintain the separation of the syngas and the compressed air. Since a large number of valves are generally present in such systems and since each valve represents an opportunity for inert gas leakage, unnecessarily high inert gas pressure may lead to significant leakage of inert gas. This can represent an economic cost and possibly require a shut down.

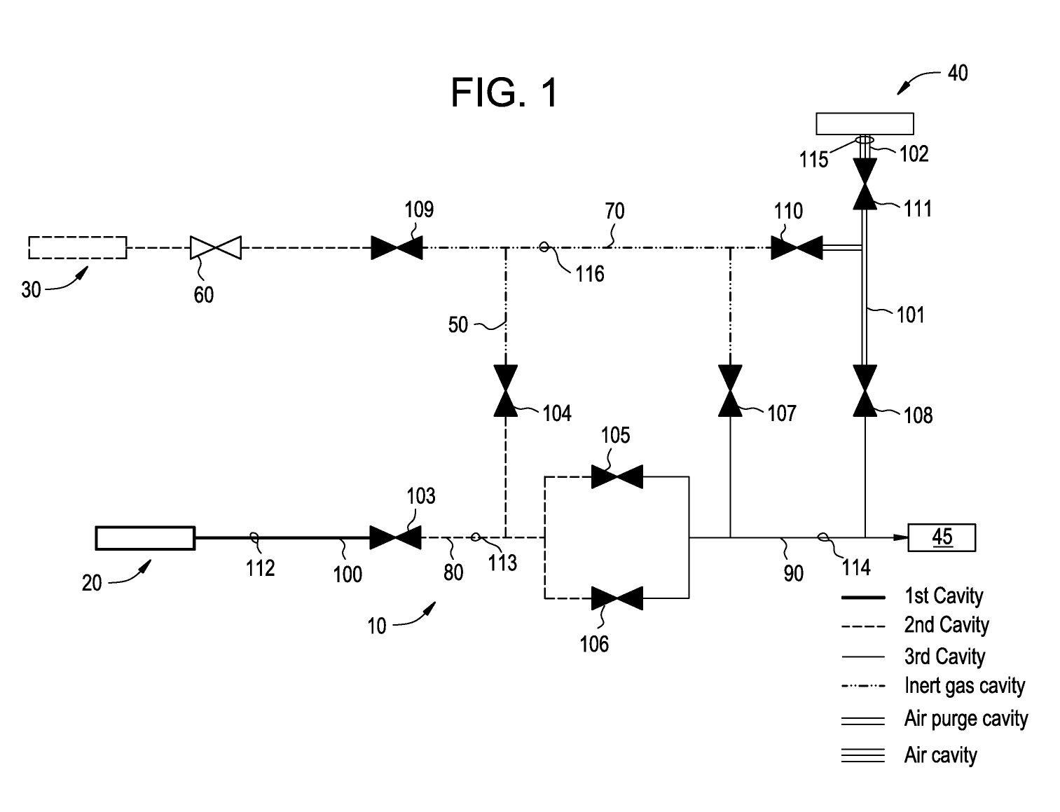

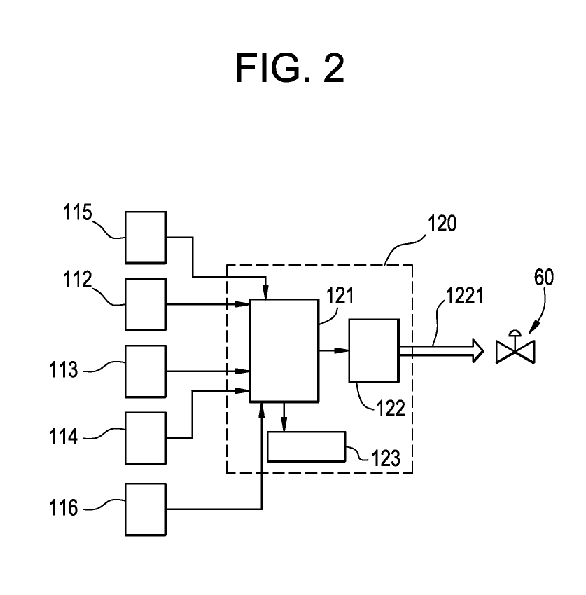

With reference to FIGS. 1 and 2, a fuel system 10 is provided for use with, for example, a gas turbine engine or a similar device. The fuel system 10 includes a fuel source 20 providing a supply of a first fuel such as synthetic gas (“syngas”), an inert gas source 30 such as a nitrogen gas source, a compressed air source 40, such as, for example, a gas turbine compressor providing compressor discharge (“purge”) air, a combustor 45 and piping 50 by which each of these elements are fluidly coupled to one another.

When the exemplary gas turbine engine runs on syngas or a secondary fuel, such as liquid fuel or natural gas, the syngas and purge air should be separated from one another. This is accomplished by identifying respective current, actual pressures of the purge air and the syngas and pressurizing the inert gas supplied by the inert gas source 30 at a given higher pressure than the identified respective current, actual pressures of either the purge air or the syngas.

The inert gas pressure may be modulated with the pressure control valve 60. The pressure control valve 60 is disposed downstream from the inert gas source 30 and is operably coupled to controller 120, as shown in FIG. 2. The pressure control valve 60 may be configured such that a modulation option provided by the pressure control valve 60 can be activated when the gas turbine engine operates on syngas and/or on the secondary or an alternate fuel.

The piping 50 may be sub-divided into a set of cavities based on a type of fuel normally carried in each cavity during various fuel mode operations. The cavities include an inert gas cavity 70, a 2^{nd} cavity 80, a 3rd cavity 90, a 1^{st} cavity 100, an air purge cavity 101 and an air cavity 102. The inert gas cavity 70 is disposed downstream from the inert gas source 30 and the pressure control valve 60. The 1^{st} cavity 100 is disposed downstream from the fuel source 20. The 2^{nd} cavity 80 is disposed downstream from the 1^{st} cavity 100. The air cavity 102 is disposed downstream from the compressed air source 40. The air purge cavity 101 is disposed downstream from the air cavity 102 and the 3^{rd} cavity 90 is disposed upstream from the combustor 45.

Respective extents of the cavities described above are delimited by a series of valves. The valves include a first valve 103 separating the 1^{st} cavity 100 from the 2^{nd} cavity 80, a second valve 104 separating the 2^{nd} cavity 80 from the inert gas cavity 70 and third and fourth valves 105 and 106 separating the 2^{nd} cavity 80 from the 3^{rd} cavity 90. Fifth valve 107 and sixth valve 108 separate the 3^{rd} cavity 90 from the inert gas cavity 70 and from the air purge cavity 101, respectively, and seventh valve 109 and eighth valve 110 separate the inert gas cavity 70 from the insert gas source 30 and from the air purge cavity 101, respectively. Ninth valve 111 separates the air purge cavity 101 from the air cavity 102.

As shown in FIGS. 1 and 2, during syngas operation, the first valve 103, the third valve 105 and the fourth valve 106 are opened, the second valve 104, the fifth valve 107, the sixth valve 108 and the ninth valve 111 are closed and the seventh valve 109 and the eighth valve 110 are opened. As such, the 1^{st} cavity 100, the 2^{nd} cavity 80 and the 3^{rd} cavity 90 will be fully supplied with syngas from the fuel source 20. Meanwhile, the air cavity 102 will be fully supplied with purge air from the compressed air source 40. The inert gas cavity 70 and the air purge cavity 101 will be fully supplied with inert gas from the inert gas source 30. The purge air in the air cavity 102 and the syngas in the 1^{st} cavity 100, the 2^{nd} cavity 80 and the 3^{rd} cavity 90 will be separated from one another by the inert gas in the inert gas cavity 70 and the air purge cavity 101 provided the inert gas is supplied at a sufficiently high pressure.

During secondary or alternate fuel operation, the ninth valve 111 and the sixth valve 108 are opened, the first valve 103, the third valve 105, the fourth valve 106, the fifth valve 107 and the eighth valve 110 are closed and the second valve 104 and the seventh valve 109 are opened. As such, the air cavity 102, the air purge cavity 101 and the 3^{rd} cavity 90 will be fully supplied with purge air from the compressed air source 40, the 1^{st} cavity will be supplied with syngas from the fuel source 20 and the inert gas cavity 70 and the 2^{nd} cavity 80 will be fully supplied with inert gas from the inert gas source 30. In this case, the purge air and the syngas are again separated from one another provided the inert gas is supplied at a sufficiently high pressure.

During syngas, secondary or alternate fuel operation, the pressure of the inert gas may be set in accordance with syngas and purge air pressure readings provided by one or more of first pressure sensor 112, second pressure sensor 113, third pressure sensor 114, fourth pressure sensor 115, and fifth pressure sensor 116. The first pressure sensor 112 is disposed in the 1^{st} cavity 100 to sense syngas pressures, the second and third pressure sensors 113 and 114 are disposed in the 2^{nd} cavity 80 and the 3^{rd} cavity 90, respectively, to sense syngas and/or air pressures therein and the fourth pressure sensor 115 is disposed in the air cavity 102 to sense the purge air pressure therein. The fifth pressure sensor 116 is disposed in the inert gas cavity 70 to sense inert gas pressure.

In accordance with embodiments, the first pressure sensor 112 will sense the maximum syngas pressure in the fuel system 10 while the fourth pressure sensor 115 will sense the maximum air pressure in the fuel system 10. The second and third pressure sensors 113 and 114 can be used for additional sensing or measurements beyond those of the first and fourth pressure sensors 112 and 115.

With reference to FIG. 2, the first, second, third, fourth and fifth pressure sensors 112, 113, 114, 115 and 116 are operably coupled to controller 120, which may be a proportional integral (PI) controller, PLC, or other programmable logic device, and which controls the modulation of the inert gas pressure by controlling an operation of the pressure control valve 60. That is, the controller 120 opens and closes the pressure control valve 60 to an opening/closing degree that is based on the determined pressures of the syngas in at least the 1^{st} cavity 100, the purge air in at least the air cavity 102, and the inert gas in cavity 70.

The controller 120 may include a processing unit 121, a servo control 122 coupled to the processing unit 121 and the pressure control valve 60 and a tangible storage medium 123 having executable instructions stored thereon. When executed, the executable instructions cause the processing unit 121 to interrogate the first, second, third, fourth and fifth pressure sensors 112, 113, 114, 115 and 116 for pressure readings of the syngas and purge air pressures and inert gas pressure and further cause the processing unit 121 to compute a necessary pressure to maintain separation between the syngas and the purge air accordingly. In accordance with embodiments, the computed necessary pressure may be an inert gas pressure that is higher than the higher reading of the syngas and purge air pressures by a predefined safe amount (i.e., by approximately 50 psi). Once the necessary inert gas pressure is computed, the executable instructions cause the processing unit 121 to operate the servo control 122 to issue a servo control signal 1221 that opens or closes the pressure control valve 60 by an amount related to the computed necessary inert gas pressure.

Thus, if a pressure of the syngas in the first fuel cavity 100 is variable and increases or decreases over time, the inert gas pressure in the inert gas cavity 70 can be correspondingly increased or decreased over time by the controller 120 opening or closing the pressure control valve 60 by an appropriate degree determined by comparing the calculated value to the current inert gas cavity 70 pressure as determined by fifth pressure sensor 116. In this way, the inert gas pressure can be actively maintained at the safe pressure without being unnecessarily highly pressurized and without risking inert gas leakage as a result.

In accordance with further embodiments, the controller 120 may control the pressure control valve 60 to open and close on a pressure schedule stored in the tangible storage medium 123 as an alternative to or in addition to the description provided above. By way of the pressure schedule, the inert gas will be brought to certain pre-defined pressures during each of one or more various operating modes of the gas turbine engine (i.e., start up modes, shut down modes, base load modes, etc.).

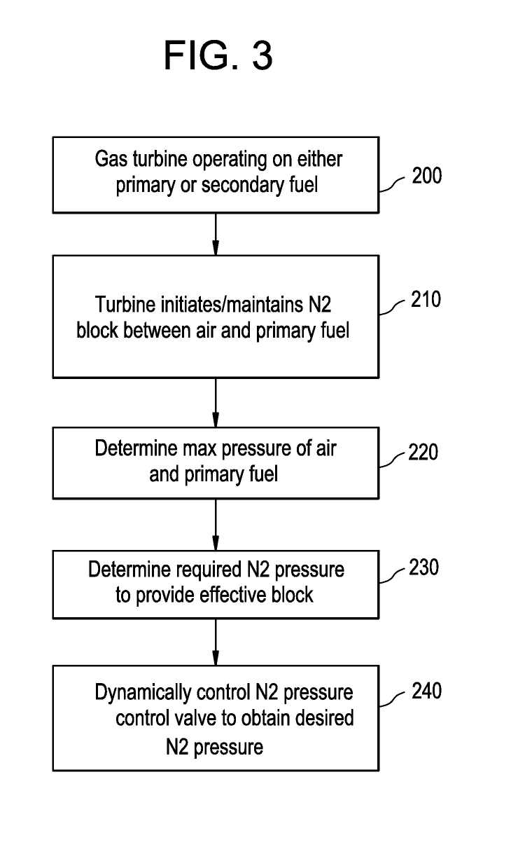

In accordance with further aspects of the invention, with reference to FIG. 3, a method of controlling an operation of a fuel system is provided and includes operating the fuel system on a primary or secondary fuel 200. The method further includes initiating or maintaining an inert gas block between purge air and the primary fuel 210 in accordance with the operating, determining respective pressures of the purge air and the primary fuel 220 and determining a required inert gas pressure to maintain the inert gas block 230. The method further includes controlling a pressure control valve 60 to modulate inert gas pressure in accordance with the determined required inert gas pressure 240.

As mentioned above, the controlling 240 may include any one or more of controlling an operation of the pressure control valve 60 in accordance with a higher reading of primary fuel and purge air pressures, controlling the operation of the pressure control valve 60 to set the pressure of the inert gas at the higher reading plus a predefined amount and controlling the pressure control valve 60 in accordance with a control schedule. Alternatively, the predefined pressure margin may be replaced with a calculated value, which would be calculated to determine the exact pressure margin necessary to maintain air and fuel separation.

In accordance with embodiments, the syngas pressure in the fuel system 10 may always be higher than the purge air pressure. As such, it may be safely assumed that the syngas pressure is always higher than the purge air pressure and that only the syngas pressure in the 1^{st} cavity 100 may be necessary to calculate the required inert gas pressure.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fuel system, comprising:
inert gas, fuel and air sources to provide a supply of inert gas, fuel and air, respectively;
piping including valves delimiting cavities therein to which the inert gas, fuel and air are supplied such that the inert gas separates the respective cavities containing fuel and air;
a pressure control valve disposed on the piping to modulate a pressure of the inert gas supplied to the piping; and
a controller coupled to the pressure control valve to control an operation thereof in accordance with at least variable pressures of the fuel and air in the respective cavities containing the fuel and the air.

2. The fuel system according to claim 1, wherein the fuel comprises syngas and the air comprises compressor discharge air.

3. The fuel system according to claim 1, wherein the pressure control valve is disposed downstream from the inert gas source.

4. The fuel system according to claim 1, wherein the controller controls an operation of the pressure control valve in accordance with a syngas pressure reading.

5. The fuel system according to claim 1, wherein the controller controls an operation of the pressure control valve in accordance with a higher reading of syngas and air pressures.

6. The fuel system according to claim 5, wherein the controller controls the operation of the pressure control valve to set the pressure of the inert gas at the higher reading plus a predefined or calculated amount.

7. The fuel system according to claim 1, wherein the controller controls the pressure control valve in accordance with a control schedule.

8. A fuel system, comprising:
a inert gas source to provide inert gas to an inert gas cavity;
fuel and air sources to provide fuel and air to fuel and air cavities, respectively, which are disposed on opposite sides of the inert gas cavity;
a pressure control valve disposed downstream from the inert gas source and upstream from the inert gas cavity to modulate a pressure of the inert gas supplied to the inert gas cavity; and
a controller coupled to the pressure control valve to control an operation thereof in accordance with at least variable pressures of the fuel and air.

9. The fuel system according to claim 8, which is operable in at least one or more of a syngas and an alternative fuel mode.

10. The fuel system according to claim 8, wherein the fuel comprises syngas and the air comprises compressor discharge air.

11. The fuel system according to claim 8, wherein the controller controls an operation of the pressure control valve in accordance with a reading of syngas pressure.

12. The fuel system according to claim 8, wherein the controller controls an operation of the pressure control valve in accordance with a higher reading of syngas and air pressures.

13. The fuel system according to claim 12, wherein the controller controls the operation of the pressure control valve to set the pressure of the inert gas at the higher reading plus a predefined or calculated amount.

14. The fuel system according to claim 8, wherein the controller further controls the pressure control valve in accordance with a control schedule.

15. A method of controlling an operation of a fuel system, the method comprising:
operating the fuel system on a primary or secondary fuel;
in accordance with the operating, initiating or maintaining an inert gas block between air and the primary fuel;
determining respective pressures of the air and the primary fuel and a required inert gas pressure to maintain the inert gas block; and
controlling a pressure control valve to modulate inert gas pressure in accordance with the determined required inert gas pressure.

16. The method according to claim 15, wherein the controlling comprises controlling an operation of the pressure control valve in accordance with primary fuel pressure.

17. The method according to claim 15, wherein the controlling comprises controlling an operation of the pressure control valve in accordance with a higher reading of primary fuel and air pressures.

18. The method according to claim 17, wherein the controlling comprises controlling the operation of the pressure control valve to set the pressure of the inert gas at the higher reading plus a predefined amount.

19. The method according to claim 15, wherein the controlling comprises controlling the pressure control valve in accordance with a control schedule.
